(19) United States
(12) Patent Application Publication
(10) Pub. No.: US 2014/0230612 A1
(43) Pub. Date: Aug. 21, 2014

(54) BIT DRIVING TOOL

(71) Applicant: SHANGHAI EASY-USE TOOLS ENT. CO. LTD., Shanghai (CN)

(72) Inventor: Shiyu Sun, Shanghai (CN)

(73) Assignee: SHANGHAI EASY-USE TOOLS ENT. CO. LTD.

(21) Appl. No.: 14/002,677

(22) PCT Filed: Jan. 10, 2013
(86) PCT No.: PCT/CN2013/070335

§ 371 Date: Aug. 30, 2013

(30) Foreign Application Priority Data
Jul. 17, 2012 (CN) 201210246975.3

(51) Int. Cl. B25B 23/00

(52) U.S. Cl. CPC B25B 23/0021; B25B 23/0035
USPC 81/177.2

(57) ABSTRACT

A bit driving tool includes a driving rod, a telescopic rod and a fixing seat. The telescopic rod is fitted in the driving rod. The fixing seat is secured to a front end of the telescopic rod. The driving rod is to fix a screw bit. The fixing seat is a magnetic fixing seat. The structure of the present invention is compact and stable, and the magnetic fixing seat can be extended or retracted easily.

### BACKGROUND OF THE INVENTION

1. Field of the Invention

The present invention relates to a screw bit driving tool, and more particularly to a screw bit driving rod with a telescopic rod.

2. Description of the Prior Art

U.S. Pat. No. 6,321,626 discloses a bit driving rod having a telescopic rod. Wherein, the driving rod and the telescopic rods are not integral, so the stability is not good and the cost is high, the structure is complicated.

Accordingly, the inventor of the present invention has devoted himself based on his many years of practical experiences to solve these problems.

### SUMMARY OF THE INVENTION

The primary object of the present invention is to provide a bit driving tool to overcome the shortcomings of the prior art.

In order to achieve the aforesaid object, the bit driving tool of the present invention comprises a driving rod, a telescopic rod and a fixing seat. The telescopic rod is fitted in the driving rod. The fixing seat is secured to a front end of the telescopic rod. The fixing seat is a magnetic fixing seat. The driving rod has an engaging seat at a front end thereof. A screw bit and the fixing seat are secured through the engaging seat.

Preferably, the engaging seat comprises a first engaging part for fixing the screw bit and a second engaging part for fixing the fixing seat. The bottom of the first engaging part is connected to the second engaging part.

Preferably, the fixing seat has a tapered rear end.

Preferably, the screw bit is a hexagonal screw bit.

The advantages of the present invention are that the structure of the present invention is compact and stable and that the magnetic fixing seat can be extended or retracted easily.

### BRIEF DESCRIPTION OF THE DRAWINGS

FIG. 1 is a perspective view according to a first embodiment of the present invention;

FIG. 2 is a perspective view showing the fixing seat of FIG. 1;

FIG. 3 is a perspective view showing the driving rod of FIG. 1;

FIG. 4 is a perspective view according to a second embodiment of the present invention;

FIG. 5 is a schematic view of FIG. 4 when in use; and

FIG. 6 is an exploded view of FIG. 4.

### DETAILED DESCRIPTION OF THE PREFERRED EMBODIMENTS

Embodiments of the present invention will now be described, by way of example only, with reference to the accompanying drawings.

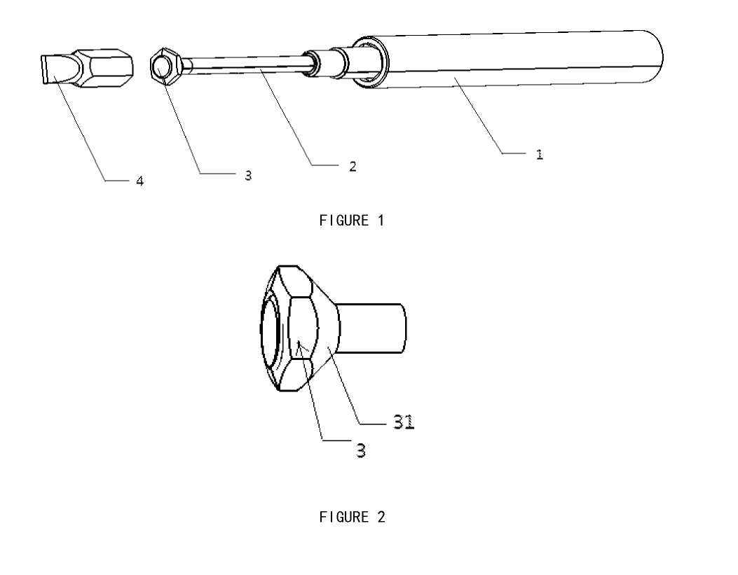

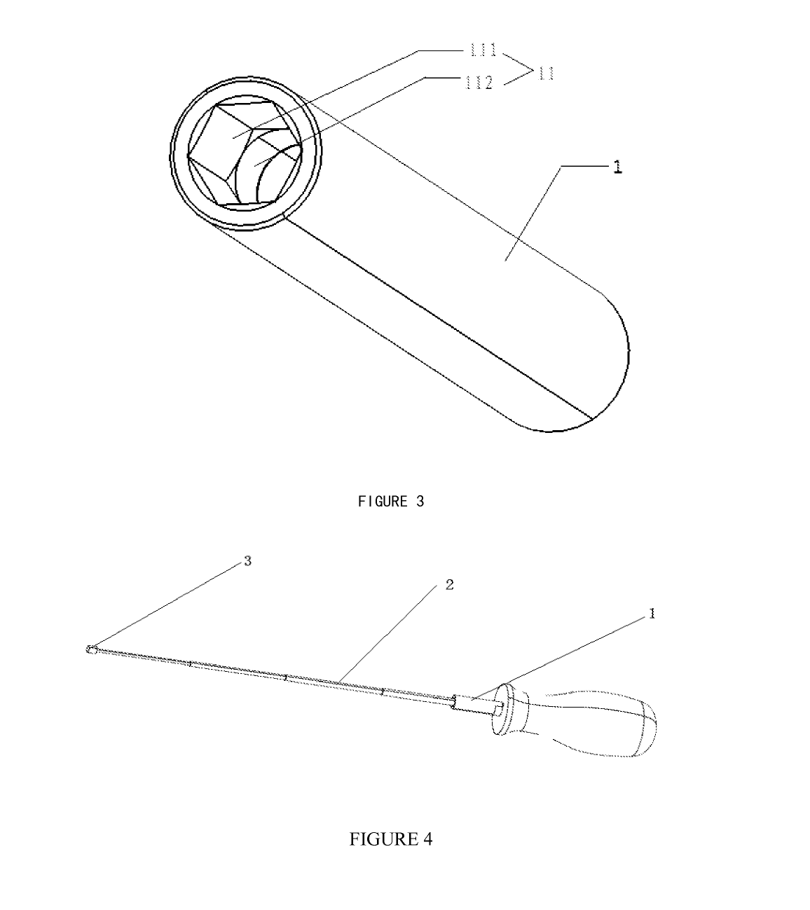

As shown in FIG. 1 to FIG. 3, the bit driving tool according to a first embodiment of the present invention comprises a driving rod 1, a telescopic rod 2 and a fixing seat 3. The telescopic rod 2 is fitted in the driving rod 1. The fixing seat 3 is secured to a front end of the telescopic rod 2. The fixing seat 3 is a magnetic fixing seat. The driving rod 1 has an engaging seat 11 at a front end thereof. A screw bit 4 and the fixing seat 3 are secured through the engaging seat 11. The fixing seat 3 has a tapered rear end 31. The bottom of the engaging seat 11 is configured to mate with the tapered rear end 31. Preferably, the screw bit 4 is a hexagonal screw bit.

The engaging seat comprises a first engaging part 111 for fixing the screw bit 4 and a second engaging part 112 for fixing the fixing seat. The bottom of the first engaging part is connected to the second engaging part.

In this embodiment, the telescopic rod is composed of a plurality of sleeves which are connected one another. The top end of the innermost sleeve is connected with the fixing seat. The outermost sleeve is engaged with the inside of the driving rod, preventing the telescopic rod from sliding out of the driving rod when the telescopic rod is extended.

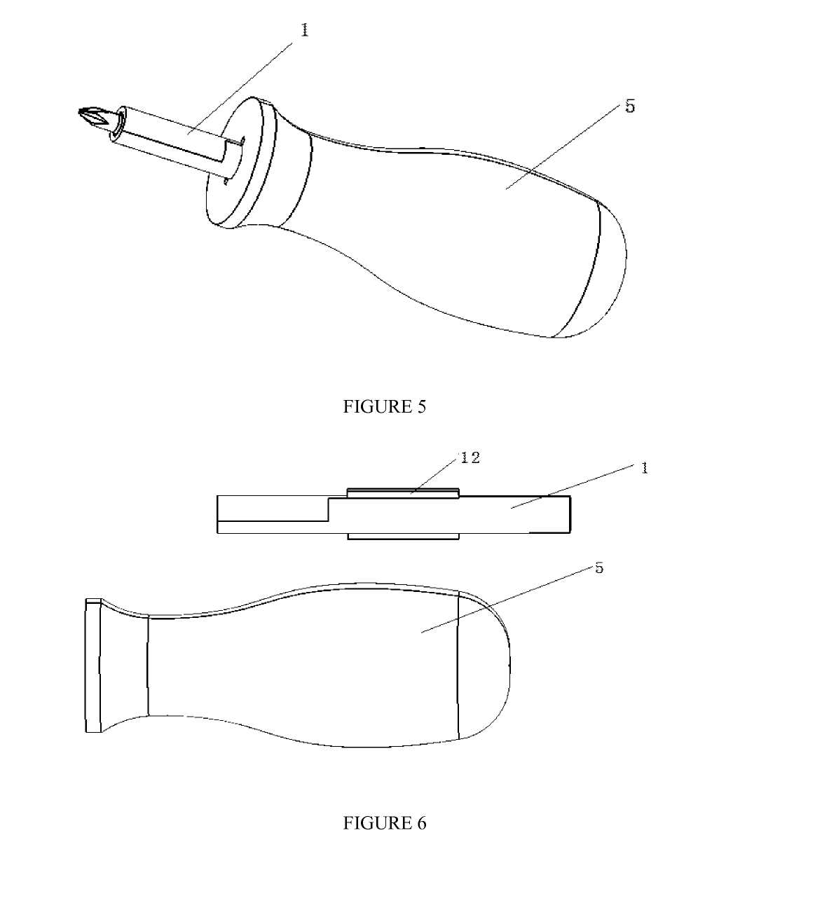

As shown in FIG. 4 to FIG. 6, the bit driving tool according to a second embodiment of the present invention comprises a driving rod 1, a telescopic rod 2 and a fixing seat 3. The telescopic rod 2 is fitted in the driving rod 1. The telescopic rod is composed of a plurality of sleeves which are connected one another. A handle 5 is fitted on the driving rod.

The outer side of the driving rod is provided with a plurality of limit protrusions 12. The handle 12 has limit grooves. The limit protrusions are slid into the limit grooves to provide a limit function for the driving rod. This can prevent slide when in use. It is convenient for use.

When the present invention is used as a screwdriver, the whole telescopic rod 2 is retracted into the driving rod 1, the fixing seat 3 is retracted into the second fixing engaging part of the engaging seat 11, and the top of the fixing seat is flush with the top of the second engaging part and confined by the engaging seat 11 to prevent the fixing seat from retracting into the driving rod 1. After that, the screw bit 4 is placed into the first engaging part of the engaging seat 11, such that the present invention can be used as a screwdriver. Because the fixing seat 3 has magnetism, the fixing seat 3 is completely attached to the screw bit 4 so the screw bit 4 won't disengage from the driving rod 1. Besides, the tapered rear end 31 of the fixing seat 3 is tightly against the engaging seat 11 of the driving rod 1 to be positioned well and to enhance the axial thrust of the screw bit. When the present invention is used as a probe, the telescopic rod 2 is pulled out. Because the fixing seat 3 is made of a magnet, it can be used to attract scattered metallic screws or metallic screw bits.

The telescopic rod and the driving rod are designed to be integral. The driving rod 1 is fitted on the telescopic rod 2 so that the driving rod 1 and the telescopic rod 2 become one-piece. The structure of the present invention is compact and stable, and the magnetic fixing seat can be extended or retracted easily.

The fixing seat 3 of the present invention is a polygonal cylinder and corresponds in shape to the engaging seat 11 of the driving rod 1.

Although particular embodiments of the present invention have been described in detail for purposes of illustration, various modifications and enhancements may be made without departing from the spirit and scope of the present invention. Accordingly, the present invention is not to be limited except as by the appended claims.

1. A bit driving tool, comprising a driving rod, a telescopic rod and a fixing seat, the telescopic rod being fitted in the driving rod, the fixing seat being secured to a top end of the telescopic rod, the fixing seat being a magnetic fixing seat, the driving rod having an engaging seat at a front end thereof, a screw bit and the fixing seat being secured through the engaging seat.

2. The bit driving tool as claimed in claim 1, wherein the engaging seat comprises a first engaging part for fixing the screw bit and a second engaging part for fixing the fixing seat, the first engaging part having a bottom connected to the second engaging part.

3. The bit driving tool as claimed in claim 2, wherein the fixing seat has a tapered rear end.

4. The bit driving tool as claimed in claim 1, wherein the screw bit is a hexagonal screw bit.
